(19) United States
(12) Patent Application Publication
(10) Pub. No.: US 2002/0171692 A1
(43) Pub. Date: Nov. 21, 2002

(54) Personalized wallpaper borders

(75) Inventor: Cheryl A. Martin, Churchville, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/829,682

(22) Filed: Apr. 10, 2001

(51) Int. Cl. B41J 3/00; B41J 2/41

(52) U.S. Cl. 347/2; 347/112; 347/115; 347/110

(57) ABSTRACT

A system and method for making a personalized wallpaper border product, includes means for providing at least one personal digital image; a work station for receiving the at least one personal digital image and arranging the at least one personal digital image in a pattern suitable for printing on a wallpaper border strip; and an inkjet printer for printing the pattern on the strip.

### FIELD OF THE INVENTION

The present invention relates to the field of printed products, and more particularly to a printed product incorporating personal digital images.

### BACKGROUND OF THE INVENTION

The use of wallpaper borders are a popular way to decorate a room. Although a large selection of wallpaper border designs is available from wallpaper manufacturers, the problem with available wallpaper borders is that the available designs are not personalized.

There is a need therefore for an improved wallpaper border product that is personalized to the user.

### SUMMARY OF THE INVENTION

The need is met according to the present invention by providing a system and method for making a personalized wallpaper border product, that includes means for providing at least one personal digital image; a work station for receiving the at least one personal digital image and arranging the at least one personal digital image in a pattern suitable for printing on a wallpaper border strip; and an inkjet printer for printing the pattern on the strip.

### BRIEF DESCRIPTION OF THE DRAWINGS

FIG. 1 is a schematic diagram showing a personalized wallpaper border product according to the present invention;

FIG. 2 is a schematic diagram showing a printer for making the personalized wallpaper border product according to the present invention; and

FIG. 3 is a schematic diagram showing a system for making the personalized wallpaper border product according to the present invention.

### DETAILED DESCRIPTION OF THE INVENTION

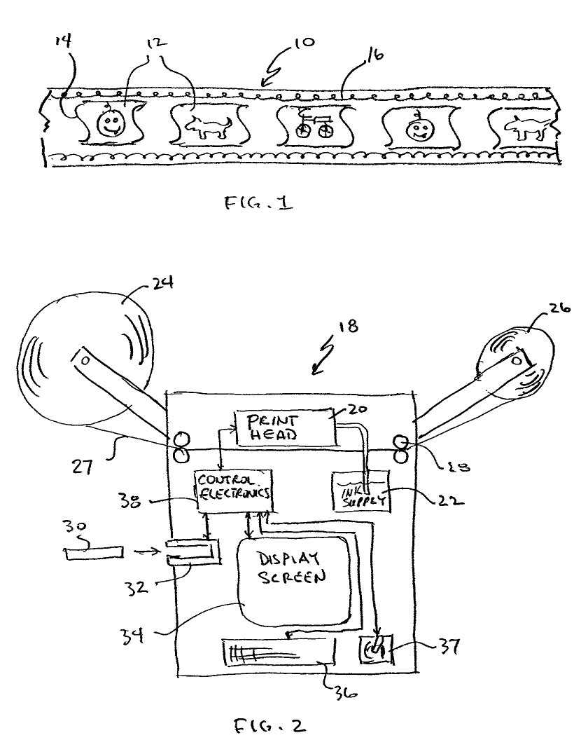

Referring first to FIG. 1, a personalized wallpaper border product 10 according to the present invention is shown. The product 10 includes a strip of wallpaper having one or more personal color images 12 printed thereon. The images may be framed in a decorative shape 14, and the product may include, for example, a decorative border 16. The wallpaper border product is used as a room decoration and is applied around the walls of a room as is known in the prior art, slightly lower than the ceiling.

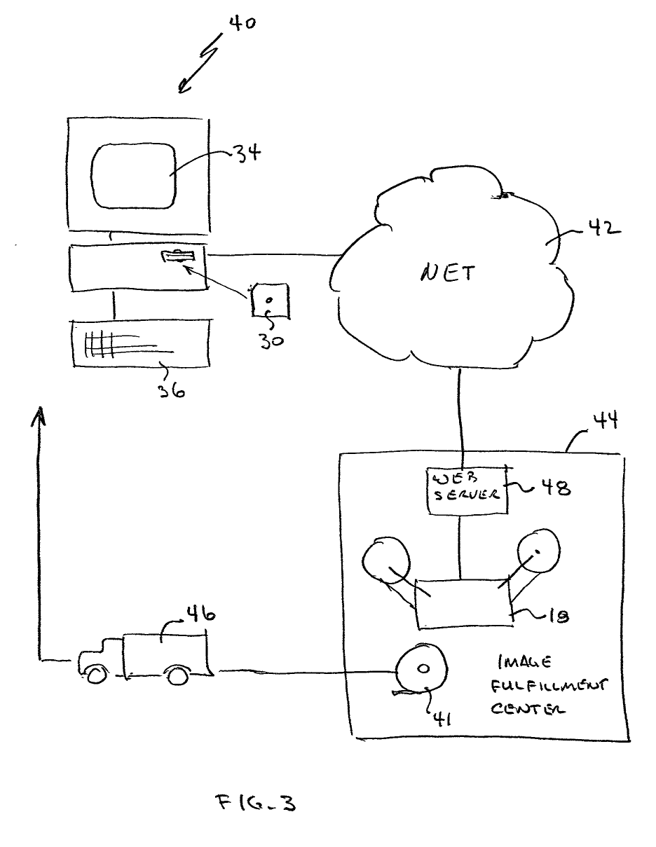

Referring to FIG. 2, a color inkjet printer 18 for generating a personalized wallpaper product according to the present invention is shown. The printer 18 includes a color ink jet print head 20, an ink supply 22 connected to the print head for delivering colored ink to the print head 20. A paper handling system includes a supply roll 24, a take-up roll 26 for holding a roll of border wallpaper stock 27, and a drive roller 28 for moving the border wallpaper past the print head 20. The printer can receive a source of personal digital images 30, such as a digital memory card or picture CD via a reader 32, or a via a computer connection to a personal computer. An operator control panel for arranging the personal digital images in a pattern for a wallpaper border, includes a display screen 34, a keyboard 36 or a joystick 37. Control electronics 38 which preferably includes a microprocessor, is connected to the elements of the printer for executing programs to allow a user to compose a wallpaper border pattern using the personal images, and for causing the print head 20 to print the pattern on the border wallpaper stock 27.

In operation, the user loads a blank roll of wallpaper border stock 27 in the printer 18, and inputs one or more personal images into the printer. The printer control electronics 38 is programmed to display the personal image(s) on the display screen 34, along with a graphic user interface that assists the user in designing a personalized pattern for the wallpaper. The graphical user interface can include for example a selection of decorative shapes for framing the personal images, and a selection of decorative borders. The interface may also provide a selection of image processing effects that can be applied to the personal image(s). After the user has designed the desired pattern, the user can input the total length of wallpaper border desired, and start the printing. The ink jet printer then applies the personalized pattern to the indicated length of wallpaper stock.

Referring to FIG. 3, according to an alternative embodiment of the present invention, the pattern is designed on a work station 40, such as a personal computer, that is connected by a communication network 42, such as the Internet to an image fulfillment center 44. The image fulfillment center 44 receives the pattern, and an order for a defined quantity of personalized wallpaper border from the remote work station 40, prints the ordered quantity on a printer 18, and delivers the printed wallpaper border 41 to the customer by common carrier 46. The work station 40 may be located in a customer's home, or in a retail establishment, such as a paint and wallpaper store. The fulfillment center can provide a web server 48 that supports a web site that can be visited by a customer at the work station to upload the customer's digital images and design the personalized border pattern.

The invention has been described in detail with particular reference to certain preferred embodiments thereof, but it will be understood that variations and modifications can be effected within the spirit and scope of the invention.

PARTS LIST

| | |
|---|---|
| 10 | personalized wallpaper border product |
| 12 | personal color images |
| 14 | decorative shape |
| 16 | decorative border |
| 18 | ink jet printer |
| 20 | ink jet print head |
| 22 | ink supply |
| 24 | supply roll |
| 26 | take-up roll |
| 27 | paper stock |
| 28 | drive roller |
| 30 | source of personal digital images |
| 32 | memory card reader |
| 34 | display screen |
| 36 | keyboard |
| 37 | joystick |
| 38 | control electronics |
| 40 | workstation |
| 41 | printed wallpaper border |
| 42 | communication network |
| 44 | image fulfillment center |
| 46 | common carrier |
| 48 | web server |

What is claimed is:

1. A wallpaper border product that includes personal images selected by a customer.

2. An ink jet printer for printing a personalized wallpaper border product, comprising:
a) a color ink jet print head;
b) an ink supply connected to the print head for delivering colored ink to the print head;
c) a paper handling system for holding a roll of border wallpaper and moving the border wallpaper past the print head;
d) a source of personal digital images;
e) an operator control panel for arranging the personal digital images in a pattern for a wallpaper border; and
f) control electronics connected to the print head for causing the print head to print the pattern on the border wallpaper.

3. A method of making a personalized wallpaper border product, comprising the steps of:
a) providing at least one personal digital image;
b) arranging the at least one personal digital image in a pattern suitable for printing on a wallpaper border strip; and
c) printing the pattern on the strip using an inkjet printer.

4. The method claimed in claim 3, wherein the pattern is arranged on a personal computing device and electronically transmitted to an image fulfillment center from a remote customer location, the printing is performed at the image fulfillment center, and the printed personalized wallpaper border product is shipped to the customer location.

5. A system for making a personalized wallpaper border product, comprising:
a) means for providing at least one personal digital image;
b) a work station for receiving the at least one personal digital image and arranging the at least one personal digital image in a pattern suitable for printing on a wallpaper border strip; and
c) an ink jet printer for printing the pattern on the strip.

6. The system claimed in claim 5, wherein the work station is located at a customer location and the color printer is located at an image fulfillment center remote from the customer location and connected to the work station by a telecommunication medium.

7. The system claimed in claim 6, wherein the telecommunication medium is the Internet.

8. An color printer for printing a personalized wallpaper border product, comprising:
a) a color printer;
b) a paper handling system for holding a roll of border wallpaper and moving the border wallpaper past the print head;
c) a source of personal digital images;
d) an operator control panel for arranging the personal digital images in a pattern for a wallpaper border; and
e) control electronics connected to the print head for causing the printer to print the pattern on the border wallpaper.

9. A method of making a personalized wallpaper border product, comprising the steps of:
a) providing at least one personal digital image;
b) arranging the at least one personal digital image in a pattern suitable for printing on a wallpaper border strip; and
c) printing the pattern on the strip using a color printer.

10. The system claimed in claim 8, wherein the color printer is a xerographic printer.

11. The system claimed in claim 9, wherein the color printer is a xerographic printer.

12. The method claimed in claim 9, wherein the pattern is arranged on a personal computing device and electronically transmitted to an image fulfillment center from a remote customer location, the printing is performed at the image fulfillment center, and the printed personalized wallpaper border product is shipped to the customer location.

13. A system for making a personalized wallpaper border product, comprising:
a) means for providing at least one personal digital image;
b) a work station for receiving the at least one personal digital image and arranging the at least one personal digital image in a pattern suitable for printing on a wallpaper border strip; and
c) a color printer for printing the pattern on the strip.

14. The system claimed in claim 5, wherein the work station is located at a customer location and the color printer is located at an image fulfillment center remote from the customer location and connected to the work station by a telecommunication medium.

15. The system claimed in claim 14, wherein the telecommunication medium is the Internet.
